(19) United States
(12) Patent Application Publication
(10) Pub. No.: US 2015/0266217 A1
(43) Pub. Date: Sep. 24, 2015

(54) PREFORM FOR BLOWMOLDING THEREOF INTO A CONTAINER AND PROCESS FOR MANUFACTURING THEREOF

(71) Applicant: RESILUX, Wetteren (BE)

(72) Inventor: William DIERICKX, Destelbergen (BE)

(73) Assignee: RESILUX, Wetteren (BE)

(21) Appl. No.: 14/507,550

(22) Filed: Oct. 6, 2014

Related U.S. Application Data
(63) Continuation of application No. 11/909,603, filed on Feb. 7, 2008, now abandoned.

(30) Foreign Application Priority Data
Mar. 25, 2005 (BE) 2005/0162

(51) Int. Cl. B29C 45/00; B32B 1/02

(52) U.S. Cl. CPC B29C 45/0055; B29C 45/00; B32B 1/02; B32B 2439/00

(57) ABSTRACT

A preform for producing containers having a neck section, a wall section and a bottom section, which is a multilayer structure having three layers, one of which (1) is directly inwardly respective the preform and is composed of a primary material (PM) thereby forming a primary basis layer (1). The primary material is a synthetic material. A further layer (3) is directed outwardly with respect to said primary layer (1), in such a way that it forms the outer surface layer (3) of the preform, thereby made of a tertiary material (TM) forming a tertiary surface layer (3). The tertiary layer is composed of a further synthetic material. In the preform, an intermediate layer (2) is provided between the primary and tertiary layers (1, 3) which is composed of a secondary material (SM) consisting of a fluid. Also disclosed is a process for manufacturing the preform.

### FIELD OF THE INVENTION

The present invention relates to a preform for the blow-molding of a container comprising a neck section, an adjoining wall section and a bottom section which forms the base of the preform, which is composed of a multilayer structure comprising at least three layers, and a container made of a synthetic material, in particular by blow-moulding thereof.

### PRIOR ART

Containers are generally expected to ensure that the characteristics and properties of the products accommodated in them are kept as stable as possible in the course of time.

EP 0 380 215 discloses a preform whose core carries a barrier layer which is intended to prevent undesirable gas particles from traversing the wall of the preform. However, the latter consists of a material that is costly to make, and the cost can be prohibitive in some cases.

A barrier layer made of solid Nylon® is also known, but a further problem here is that material is quite hydrophilic, so that moisture can enter the preform through the barrier layer at the injection point of the preform. The disadvantage of such materials is that they have a pronounced tendency to absorb moisture, causing delamination when the preform is being converted into a container. The secondary core layer thus loses its barrier properties and in addition the container suffers undesirable discoloration.

Since the known secondary materials such as nylon are very hydrophilic, the problem with the known preforms of this type is that moisture seeps in through their base, exerting an undesirable effect on them.

### AIM OF THE INVENTION

The aim of the present invention is to provide a preform of the above type, but one with an effective barrier layer for a wide range of applications on the one hand, and at an acceptable cost, on the other hand.

The aim is therefore to ensure the best adhesion between the various layers. Some liquids are more compatible with the primary material, such as polyethylene terephthalate (PET), than with a number of currently employed secondary materials such as nylon, which are not compatible in this respect.

### SUMMARY OF THE INVENTION

For this purpose, there is proposed a preform according to the present invention as defined in the main claim. A fluid is thus incorporated in it as a secondary material, forming the barrier layer.

Such a secondary material can be applied more evenly. This has the considerable advantage that less secondary material is needed for the layer, so the cost is reduced. Furthermore, a better structure is obtained, resulting in a better barrier layer. This is directly due to the behaviour of fluids, which have a natural tendency to fill in a given volume evenly, causing considerably less delamination between the layers.

Thanks to the use of a fluid as the secondary barrier material, the barrier layer can be applied over the entire length of the preform, from its base right up to its neck next to the rim for pouring out the contents. As a result, almost the same barrier effect can be achieved over the whole height of the container made in this way, even in the neck region, which is not available in the prior art. The reason for this advantage is that fluids ensure a perfectly uniform filling of the space between the primary and the tertiary layer.

This is a very important advantage, because the product accommodated in the container obtained from the preform can then perfectly retain its characteristics without suffering any degradation in the course of time, owing to undesirable interactions with the surroundings or even with the interior of the container.

Thanks to the invention, less secondary material is needed in relative terms, which means that the same barrier properties are retained without the delamination problem mentioned above. Accordingly, in the preferred embodiment of the invention, this amount is less than 5% and especially less than 1%, while ensuring the same barrier effect.

According to a remarkable embodiment of the invention, the secondary layer has a very small thickness, preferably not more than 0.05 mm and especially even less than 0.01 mm.

According to another basic embodiment of the invention, the secondary material is a liquid. This has the great advantage that it forms an efficient liquid barrier along the entire length of the preform, including its neck region.

Secondary materials that have a lower viscosity under normal working conditions of temperature and pressure, referred to below as “cold liquids”, are the best in this connection.

According to another preferred embodiment of the invention, the secondary material is an oil and more specifically an oil-based substance. Water is also a possibility, and more specifically a water-containing substance. This means liquids wherein water is bound. Particularly advantageous is in this connection the excellent lamination that can be obtained with these, because of fewer problems concerning compatibility between the various layers.

In another advantageous embodiment of the invention, the said secondary material is a polyolefin, especially polyethylene or also polypropylene, which are particularly recommended as vapour barriers. Thus, a polyethylene film is especially suitable for keeping vapour or moisture out.

In further advantageous embodiment of the invention, the said secondary material is an acrylate with a water and/or oil basis. This type of barrier to liquids is particularly suitable for biological applications. Acrylates are very good barriers to acids indeed. Oil-containing acrylates form ideal carriers for so-called active barriers.

Thanks to the lamination effect that occurs in liquids, a preform according to the invention offers particularly valuable properties. Thanks to the limited thickness of the secondary layer that can thus be made, it is now finally possible to use nano-scale composites for the secondary layer, especially those based on clay, wherein more specifically, the intrinsic properties of these composites can be fully utilized here, owing to lamination, This has actually become possible because the secondary layer can be applied more evenly. This material has a particular property of excellent covering ability, making a particularly extensive coverage possible.

In yet another embodiment of the invention, the secondary material is in the form of a coating, especially one made of polyurethane, which scores by having favourable properties at elevated temperatures.

In an especially preferred embodiment of the invention, the said secondary material is a liquid polymer, especially a polymer-bioaggregate (PBA), which materials are described in detail in Patent application BE 2004/0431, whose teaching forms an integral part of the present patent application. Yeast strains and yeast cells are resistant to temperatures of up to about 170° C. if the corresponding exposure time is relatively short, namely of the order of 0.1 sec.

Further characteristics thereof are specified in the various sub-claims.

In an alternative embodiment of the invention, the secondary material can also be a gas.

In an additional embodiment of the invention, said preform is composed of five layers, with said secondary layer carrying an intermediate layer at least on its side that is in contact with the adjacent primary layer and the tertiary layer, wherein the quaternary layer also consists of a fluid.

It should be understood that the fluids mentioned above can be both liquids and gases, but they can also be intermediate phases such as pastes and other substances comprising a normal liquid phase, such as e.g. adhesives.

In an especially advantageous embodiment of the invention, the secondary, respectively quaternary layer(s) carry an adhesive layer that has been treated with yeast cells, so that a mechanical adhesion with the primary and tertiary layers is ensured.

In another advantageous embodiment of the preform according to the invention, at least the outward-facing tertiary layer carries a predetermined amount of additives that are incorporated in the plastic forming the tertiary layer. Thanks to the presence of additives, any substance that might migrate from outside the container into its inside becomes chemically bound and thus neutralized, so it cannot reach the product that is accommodated in the container.

Conversely, the additives present in the primary layer similarly ensure that substances that are detrimental to the product accommodated in the container are similarly bound, so that these internal constituents likewise cannot cause any degradation in the product inside the container.

In a specific embodiment of the preform according to the invention, the said primary layer contains additives that neutralize external radiation, particularly ultraviolet rays, so that a light barrier is formed therewith. This effect is advantageous in the case of products such as milk, because light causes the greatest degradation to milk and especially to the vitamins in it.

In yet another advantageous embodiment of the preform according to the invention, the primary layer contains additives that counteract undesirable gas formation, thereby providing a so-called barrier to gases. This is primarily intended against carbon dioxide or oxygen that is formed in the degradation of a product in the container and which is present in the latter together with the filling product, especially in the ullage space above the filling level, where no filling product of the drink-type is present. This barrier to gases can prevent the oxidation of a drink packed in the container.

In yet a still further advantageous embodiment of the preform according to the invention, the inward-facing tertiary layer contains additives that neutralize the deleterious reagents that stems from the container material itself and which are formed in the basic plastic, especially polyethylene terephthalate (PET), during the production of the preform in an injection moulding machine, such a deleterious reagent being especially acetaldehyde. This gaseous compound is not toxic, but it can give rise, however, to a sweet taste in a liquid product, since it is readily soluble in water at room temperature. Thanks to this measure consisting in use of said additives as chemical blockers, the migration of acetaldehyde from the wall of the preform into the product accommodated therein is prevented, so that the taste of said product is not altered by it. It could be established that these chemical blockers can be best incorporated in the wall of the preform by using a liquid barrier layer according to the invention.

In further particularly remarkable application, cobalt is incorporated, which has the property of being a particularly good oxygen getter, but it is highly toxic, so that this element cannot be presently used in the existing technology, at least not in containers used for drinks. However, this becomes possible indeed when a liquid barrier is employed according to the present invention.

In a preferred embodiment of the preform according to the invention, said secondary layer is a passive barrier and is at least less permeable, preferably completely impermeable to substances that might possibly migrate to it, such as oxygen, carbon dioxide, etc. Thanks to the presence of such a barrier layer, said potentially migrating substances are arrested, so they cannot penetrate through the wall of the container. The excluding action of the barrier layer operates in both directions, in that it prevents the inward penetration of undesirable substances, such as e.g. oxygen, into the container when the latter contains products that can be oxidized, decomposed or spoilt, or a product that can suffer a quality reduction, under the influence of such gaseous substances.

There is another way whereby the barrier layer prevents the migration of any potentially desirable gaseous components from the product present in the container through the walls of the latter to the outside, as in the case of drinks enriched with extra carbon dioxide, such as soft drinks and beer.

The migration of particles is advantageously prevented in both directions, i.e. both from the interior to the outside and from the surroundings to the inside of the container.

In a further additional embodiment of the preform according to the invention, the secondary material has a chemical affinity for said undesirable substances to such an extent that it reacts with them and so “locks” them in the container wall itself, thus preventing them from escaping or penetrating into the interior of the container.

In a specific embodiment of the preform according to the invention, said secondary layer further contains additives that have the same function as those stopping the migration, excluding undesirable gas components and screening out radiation.

The present invention also relates to a process for the production of a preform or container as specified in the corresponding process claims and as described below in further detail.

In the process according to the invention, a fluid is thus introduced as a secondary barrier layer directly through the injection point or sprue, while the conventional screw in the heating block only serves to inject the primary and tertiary layers.

In a preferred embodiment of the process according to the invention, the secondary material is fed in cold, directly through the sprue.

The present invention also relates to a device for the production of a preform or container as specified in the corresponding device claims and as described below in further detail for the execution of the methods claimed therefor.

Further particularities and characteristics of the invention are specified in the further sub-claims.

### BRIEF DESCRIPTION OF THE DRAWINGS

Further details are illustrated in the following examples with reference to the attached drawings, which are described below.

FIG. 1 to 3 are each a diagrammatic representation of a cross section in a central plane of respective embodiments of a preform according to the invention;

FIG. 4 is a diagrammatic representation of a partial cross section through the axis of a first embodiment of a preform according to the invention;

FIG. 5 is a similar representation of a variant of the preform according to the preceding figure;

FIG. 6 is a similar representation of a second embodiment of a preform according to the invention;

FIGS. 7 to 9 are each a detailed view of a part of the preform represented in FIGS. 1 to 3 respectively according to the invention;

FIGS. 10 to 13 are each a diagrammatic representation of the functional working of an essential part of the preform, resp. container according to the invention;

FIGS. 14 and 15 are a mixed representation of a container according to the invention, partially in a front view and partially in a cross section, with an enlarged view of a detail of the wall thereof;

FIG. 16 is a diagrammatic representation of a first embodiment of a manufacturing device of the preform according to the invention;

FIG. 17 is a diagrammatic representation of a second embodiment of a manufacturing device of the preform according to the invention;

FIG. 18 is a more detailed representation in cross section of an essential part of the device as represented on FIG. 16.

### DESCRIPTION

The invention generally relates to a plastic container, or to a preform for making it, including the so-called barrier technique, using a multilayer structure that comprises a barrier layer.

This multi-layer structure is shown in the drawings in the case of a preferred use of the preform as a semi-finished product in the blow-moulding of preforms for making containers. It relates essentially to containers for packaging and storing drinks, food products, cosmetics, etc. in the liquid, solid or even gaseous state, such as e.g. bottles, jars, goblets, beakers, tins, jerry cans and the like.

FIG. 1 shows a container in its semi-finished form as a preform 40 that essentially has a neck region 8 forming a pouring spout, a proper wall section 6 that is to be blown up in order to form the container, and a bottom section 7 forming the base. The neck region 8 of the preform surrounds a pouring opening 11 out the product at one end and leads to said wall section 6 of the preform at a neck ring 9. At the bottom 7, said secondary layer has a bent 47 towards the base and extends further out, beyond its free end 49. This is shown in greater detail in FIG. 7.

This last embodiment is particularly useful when said barrier layer 2 is rather directed to the outside of the preform wall 6. This is the best embodiment for laminate applications typical of liquid barriers.

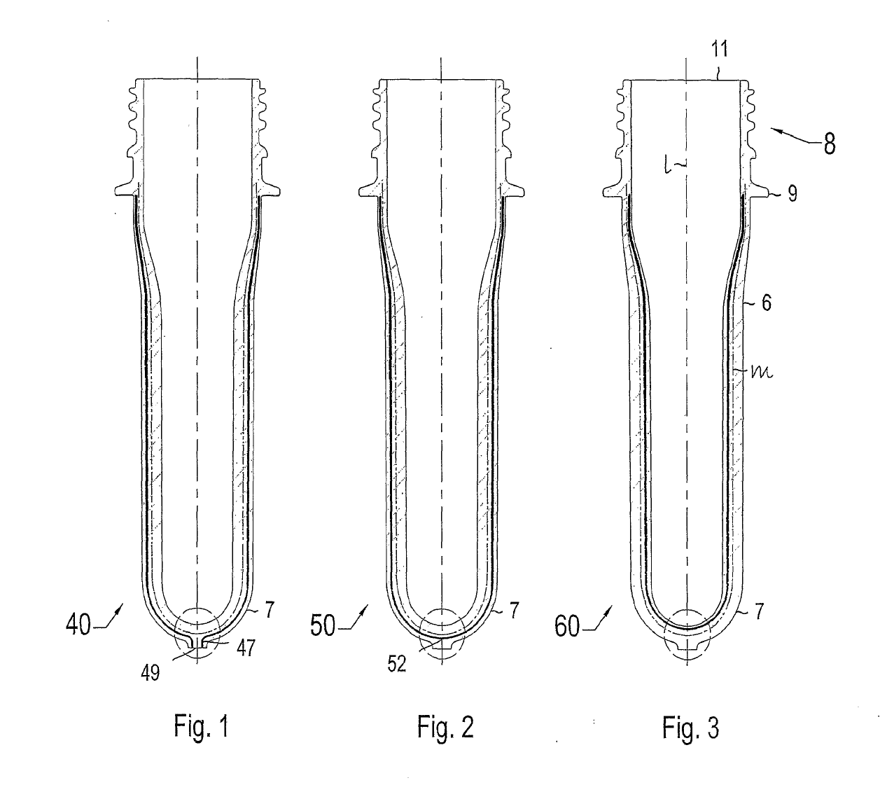

FIG. 2 shows a further variant of the preform 50, in the case of which the core layer 2 is interrupted 52 in the base area 7.

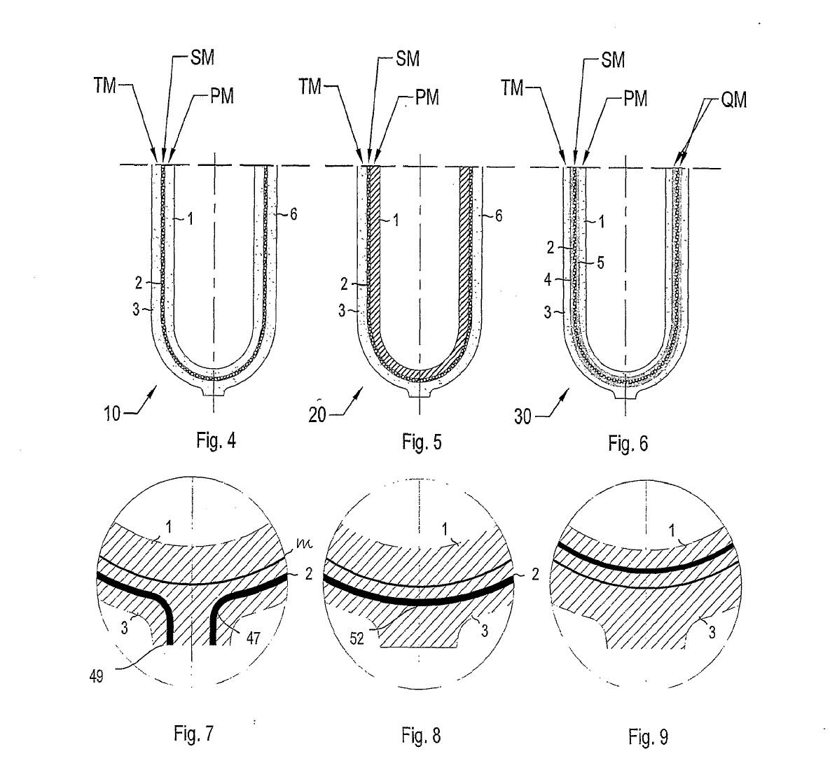

A further variant is shown in FIG. 4, wherein the core layer 2 continues in the base area 7 of the preform 60, with the longitudinal axis l, and the core layer 2 is directed to the inside of the preform with respect to the central line m, as shown in the fig.

FIG. 4 shows the multilayer structure 1, 2, 3 of a preform 10. The base 7 of the preform has an injection point 47, where the primary material PM and the tertiary material TM can be injected into an injection mould provided for this purpose but not shown in the drawings, and where the secondary material SM can be carried therewith.

The layer 1 facing the inside of the preform is made of said primary material, while the layer 3 facing the outside of the preform is made of said tertiary material, both of which are made of the same material consisting of plastic.

A secondary layer 2 is present between the primary 1 and tertiary 3 layer, which is made of said secondary material so that said secondary layer forms an intermediate layer. Said secondary layer constitutes a barrier layer in the sense described above.

FIG. 5 shows a variant, wherein the preform 20 with a fluid barrier consists of three layers, in which the primary and tertiary layers 1, 3 are made of two different plastics.

This barrier layer 2 can form both an active and a passive barrier, in the meaning that in the case of a passive barrier, the secondary material is impermeable or less permeable to certain substances, such as oxygen and carbon dioxide, and therefore arrests their migration. In the case of an active barrier, on the other hand, the secondary material reacts with a certain substance and thus “locks” harmful and/or undesirable substances in the wall, i.e, by chemically binding with them, so that they cannot escape or penetrate inwards.

The barrier layer forms at most 5% and preferably no more than 1% of the total weight of the preform, depending on the application in question.

In one example, the barrier layer consists of oil or water, or preferably of liquids with an oil or water base.

In another example, the secondary layer consists of a polymer-bioaggregate (PBA), where the yeast strains and yeast cells can tolerate a higher temperature of up to about 170° C. if the period of exposure is relatively short.

Coatings, such as polyurethane coatings for example, have the advantage that they can be used at higher temperatures as well.

Said primary and tertiary plastics are advantageously made of polyethylene terephthalate (PET). They can also be made of polypropylene, polycarbonate or otherpolymers.

The primary and the tertiary material can also consist of plastics that contain additives 71, 73 as represented in FIGS. 12 and 13. Vitamins is an example of such additives used.

Furthermore, such preforms can be fully recycled. The primary material can also possibly be made of a mixture of a recycled material and additives.

More particularly, said primary plastic can contain additives 71 as shown in FIG. 12 that bind any undesirable oxygen that migrates into the container from outside, thus preventing it from reaching the product present in the container.

This additive can also ensure that the oxygen present in the container together with the drink, especially in the ullage space above the filling level of the drink is bound, so that it cannot cause any oxidation either.

A further additive consists of colouring agents, making the barrier layer into a light barrier. Ultraviolet rays can be kept out of the container, which is useful, because light causes the most degradation in milk and especially in the vitamins contained in it.

Another additive is a substance that binds acetaldehyde (AA). AA is a substance formed from polyethylene terephthalate during the production of the preform in an injection moulding machine. If acetaldehyde migrates out of the wall of the bottle into the product contained in it, it can cause a change of the taste of the drink, especially if this is carbonated water. Carbon dioxide is a very unstable gas, which readily combines with other substances. It produces a sweet taste, which creates an unpleasant impression in the drink, especially in the case of water, so it should be prevented.

The above description illustrates the influence of a suitable position of the secondary layer 2 in the preform. The fact is that, if the secondary layer faces the outside of the preform as shown in FIGS. 1 and 2, the polyethylene terephthalate layer, containing the additives, is thicker. If additives 71 are present in the primary polyethylene terephthalate layer 1, this allows more functional components to be in contact with the product. More oxygen coming from the preform can thus be bound, as shown in FIGS. 12 and 13.

The secondary material SM is intended for forming a barrier layer e.g. to stop oxygen from migrating through the preform wall. The inward penetration of oxygen in the preform must be prevented if the container is accommodating products that are oxidized, decomposed, spoilt or reduced in quality by oxygen, examples of such products being milk and fruit juices, as shown in FIG. 10.

This oxygen-excluding barrier layer is also important when the container accommodates water to which extra oxygen has been added. In this case, this layer prevents oxygen from traversing the walls outwards, then resulting in a loss of the quality of the water.

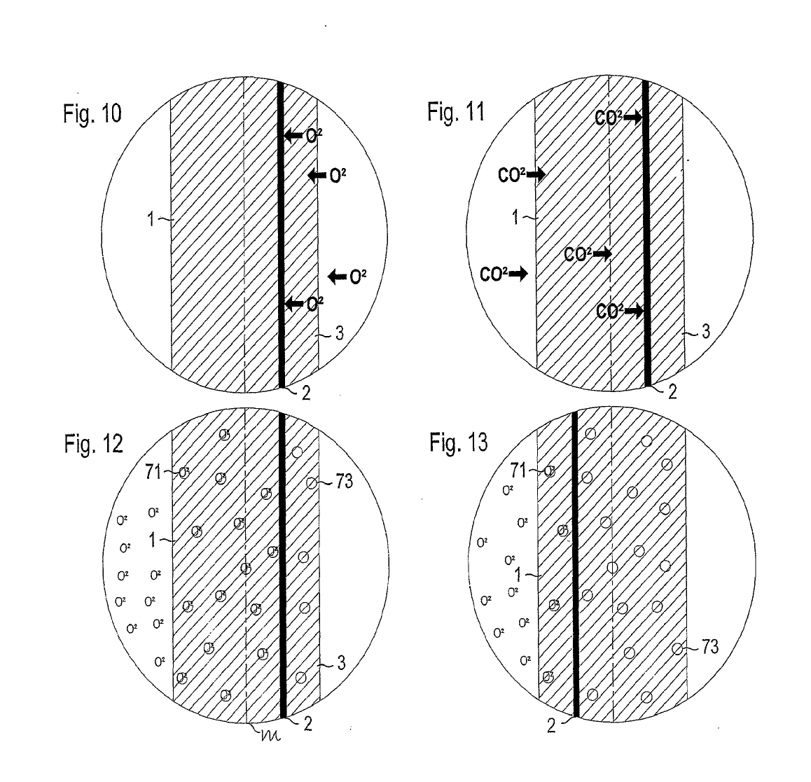

The barrier layer as shown in FIG. 11 is used for preventing the outward migration of carbon dioxide through the wall of the preform. The loss of carbon dioxide from the container must be prevented whenever the latter contains a soft drink or beer, for example, since such a loss reduces the quality of the product.

A gas barrier can still further have the same function of stopping the migration of oxygen and carbon dioxide, as well as excluding UV radiation.

A further variant of preform 30 is partially shown in FIG. 6. The preform has five layers. The secondary layer 2 carries on each side an intermediate layer 4, 5 made of a quaternary material QM consisting of a fluid. Said fluid is advantageously formed by an adhesive used to prevent delamination between the primary, secondary and tertiary layer of the preform.

In a particularly advantageous variant, each adhesive layer 4, 5 is treated with yeast cells.

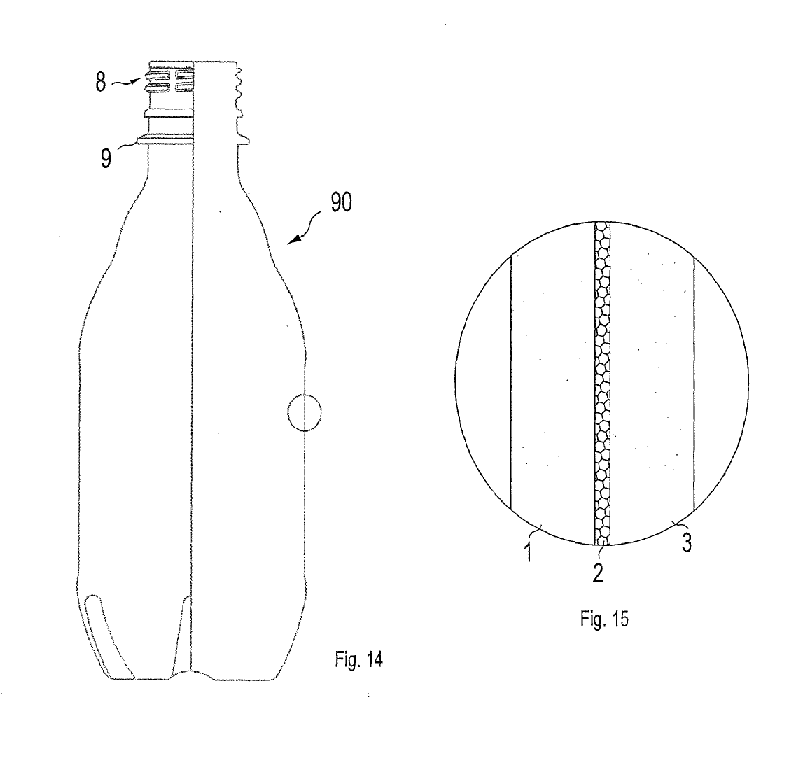

A container as such is presented in its finished form in FIG. 14, a detail of which shows the wall in FIG. 15, showing a wall of the type represented in FIG. 4 by way of example.

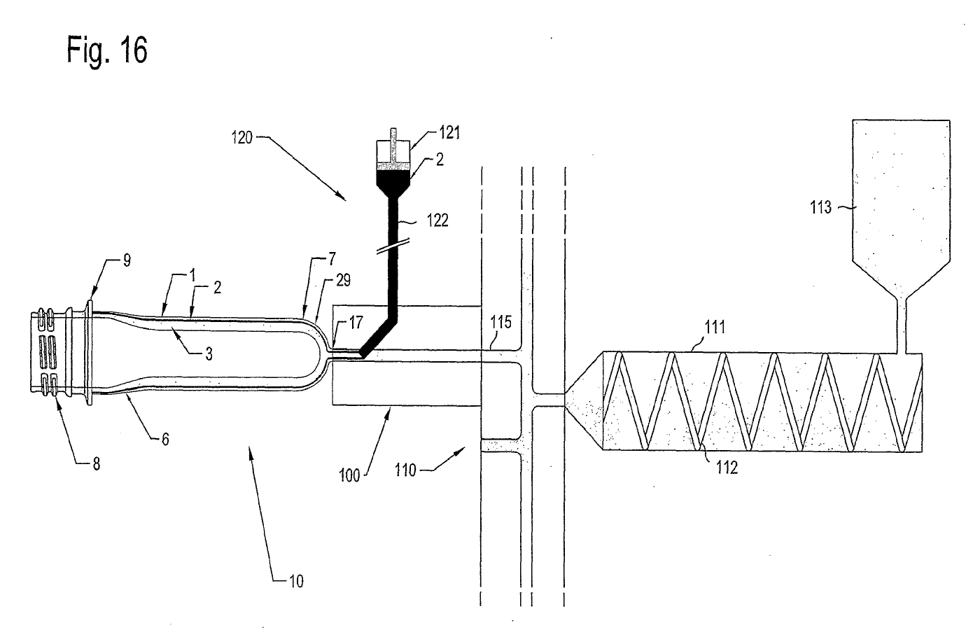

FIG. 16 shows a device for making the preform described above, where the primary plastic and, if need be, the tertiary plastic are fed in conventionally by means of a primary feed device 110, more specifically an injection moulding equipment at a certain temperature T and pressure p.

The temperature T in this part 110 of the device is relatively high, being typically about 240° C., so that the primary plastic PM and, if need be, the tertiary plastic TM, introduced by the conventional injection method, are heated to a higher temperature than their melting point at atmospheric pressure. In the conventional device, the primary feed device 110 mentioned above is mounted at a certain distance from the base area 7 of the injection mould (not shown) that is used for making the preform, this distance being measured along its axis 2. The material is thus transferred from the processing unit 111 to the injection mould at an elevated temperature, this being called “warm inlet”, said processing unit comprising a screw 112 used in the well-known production process, as described e.g. in EP-A-0686081, which screw is supplied with the primary plastic and, if need be, with the tertiary plastic from a reservoir 113, using a system of feed channels 114. The required basic material for a specific preform is supplied from the corresponding feed channel 115 that is specifically intended for use when making one preform 10.

Independently of the warm inlet 110 mentioned above, a fluid is introduced in the featured way at a relatively lower temperature, typically at about room temperature, while a higher temperature T prevails on the primary side 110. For this purpose, the secondary material is introduced through a feed channel 122 that connects a fluid reservoir 121 with the sprue 17 of the injection mould mentioned above. This fluid reservoir 121 is kept at room temperature and at atmospheric pressure.

In a variant as shown in FIG. 16, the secondary material can be fed in under pressure as well, e.g. by means of a pump 127 or an injection moulding system but without using a screw. If need be, the secondary feed temperature can be higher than said room temperature but significantly lower than the primary temperature T prevailing on the primary side 110.

The secondary feed device 120 is arranged outside said basic feed device 110. Owing to this mutually separate arrangement, it is possible to ensure different working temperatures for both primary 113 and secondary reservoirs 121, on the one hand, but it also becomes possible to use a secondary feed device 120 that has a considerably simpler structure, on the other hand.

Thanks to said “cold inlet” by means of said secondary feed device 120, it is possible to use fluids of a special type, containing said polymer-bioaggregates (PBAs), which substances are particularly sensitive to the temperature. Such PBAs cannot withstand the temperatures needed for processing in the basic feed device 110, indeed.

A preform 10 consisting of three layers as shown in FIGS. 4 and 5 is achieved with said split feed device 110, 120. It should be mentioned here that the secondary feed device 120 is arranged outside the basic feed device 110 in order to make it possible to use different processing temperatures, as described above.

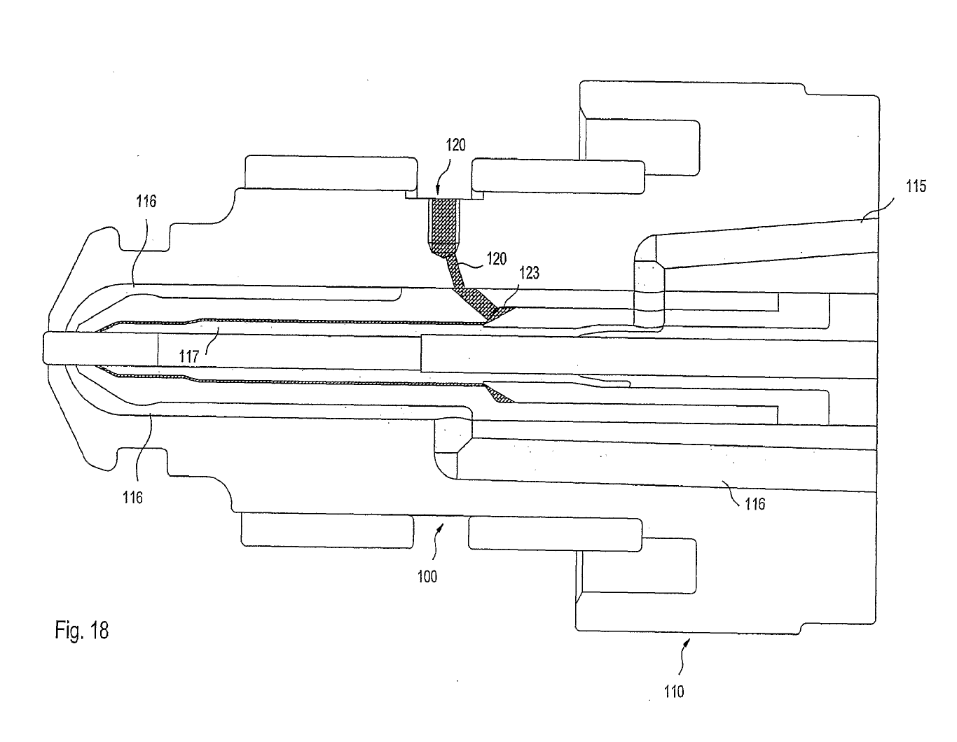

In an embodiment of the production process of said preform 10, the primary layer 1 is formed by feeding the primary plastic through the corresponding feed channels 114, while the secondary layer 2 is formed by feeding the corresponding secondary material through a separate feed channel 122 provided for it. If required, the secondary material is introduced through an inlet dye 123 provided for it, shown on FIG. 18. This fig. shows a detailed representation of a mixing block indicated schematically with 100 in FIG. 16. The way the secondary material is applied over a relatively short distance d from the sprue 17 upstream of the preform mould is shown schematically therein. The secondary fluid material is advantageously introduced over the primary material in a peripheral manner, using an annular feed element 123. In this method, the secondary material is conveyed jointly with the primary material under the influence of the lamination effect, which is typical of liquids. Especially in the case of said biological applications, particularly said polymer-bioaggregates (PBAs), the joint feed distance d for the primary and secondary material will be kept as short as possible, as a result whereof, the secondary material, which is held at a comparatively lower temperature, is exposed for the shortest possible time to the significantly higher temperature of the primary and tertiary materials originating from the heating block 110.

The connection 37 is arranged at a relatively short distance d from the sprue 17 with respect to the inlet of the primary feed channel 115 in the injection “nose” 100, so as to minimize the common distance and hence the time over which the secondary and primary materials come into contact with each other before reaching the mould, The heating effect exerted on the secondary material by the co-flowing primary material can therefore be minimized, which is quite advantageous, because excessive heating-up is particularly undesirable in some cases, especially beyond a certain temperature, as in the case of said polymer-bioaggregates (FBAs).

The secondary material is thus fed in not through the heating feed block 110 but outside it, directly through the injection “nose” 100 mentioned above.

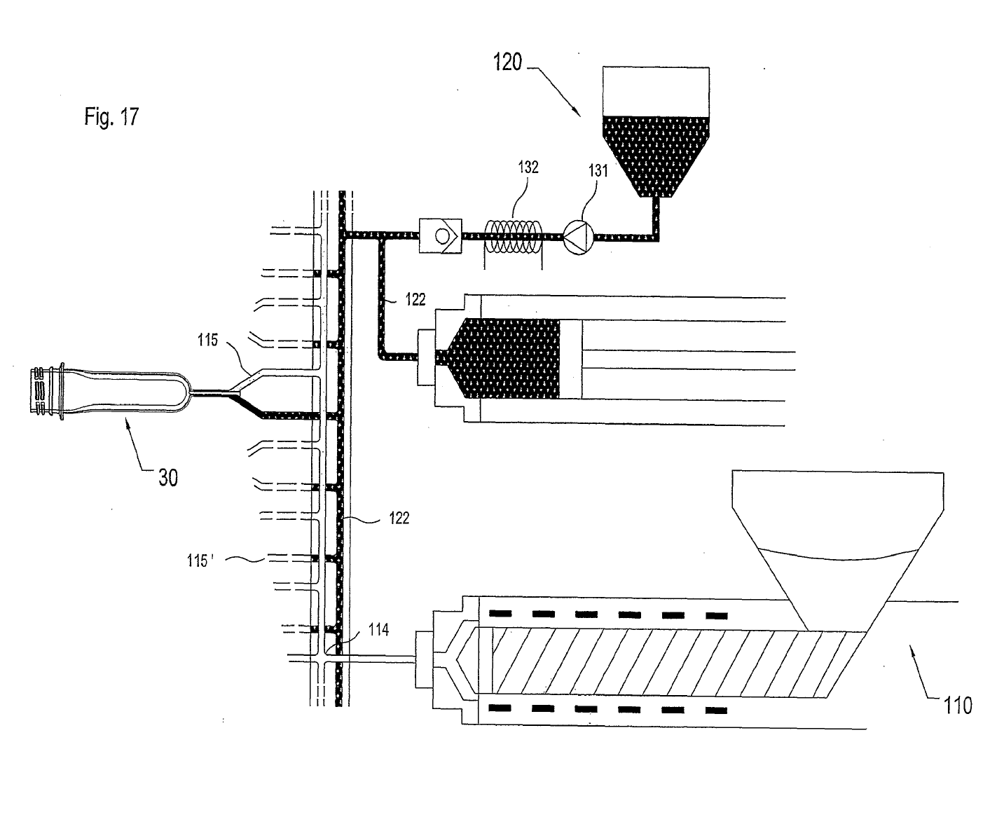

FIG. 17 shows a variant of the device for making a multilayer preform as shown in FIG. 6. The primary and tertiary plastic layers are formed by introducing the primary material PM and the tertiary material TM at an elevated temperature from the basic device 110 through the feed channel system 114 provided for this purpose, with one such feed channel 115 being used for each preform 30 to be produced, as described above. The secondary layer is fed in through the cold inlet system 120, as described above, using the secondary feed channels 122 provided for this purpose, which are kept under pressure by means of a pumping system 131 and are subjected to the action of heating elements, such as electrical resistances 132, for example, as a result whereof, the viscosity of the fluid introduced can be modified by heating. For example, this viscosity can be considerably reduced, as with adhesives for example, intended especially for forming an intermediate adhesive layer 4, 5 to counteract delamination.

The secondary polymer SM and, if required, the quaternary polymer QM can be e.g. a polyolefin, such as polyethylene or polypropylene, polyethylene terephthalate, polyesters, and other polymers.

1. A preform for producing containers, comprising a neck section, an adjoining wall section and a bottom section forming the base of the preform, said preform comprising a primary layer directed inwardly with respect to said preform and composed of a primary synthetic material, a tertiary layer which is directed outwardly with respect to said preform, thereby forming an outer surface layer composed of a tertiary synthetic material, and a secondary layer positioned between said primary and tertiary layers to form a multilayer structure, said secondary layer being a barrier layer arranged as an intermediate layer composed of a secondary material that constitutes less than 5% of the total weight of the preform and wherein said secondary material comprises a polymer bio-aggregate composed of cells and/or cell products and a polymer.

2. The preform according to claim I, wherein said secondary layer has a thickness not exceeding 0.05 mm.

3. The preform according to claim 1, wherein at least one additional intermediate layer, which is composed of a quaternary material, is provided between and contacting the primary layer and the secondary layer and/or between and contacting the primary layer and the tertiary layer.

4. The preform according to claim 1, wherein at least one of said materials or layers comprises further additives.

5. The preform according to claim 4, wherein said additives consist of dying substances.

6. The preform according to claim 5, wherein said additives have a neutralizing action on external radiations and/or substances.

7. The preform according to claim 4, wherein said additives have a neutralizing action on substances which have an adverse effect on a product to be contained.

8. The preform according to claim 4, wherein said additives have a neutralizing action on undesired gas formation originating from the degradation of a product to be contained.

9. The preform according to claim 4, wherein said additives have a neutralizing action on waste or degradation materials originating from the preform itself.

10. The preform according to claim 1, wherein said primary and tertiary materials are mutually different.

11. The preform according to claim 1, wherein said cells are composed of cysts and/or or are in inactive or sleeping stages of their life cycle.

12. The preform according to claim 1, wherein said cells are composed of yeasts.

13. The preform according to claim 1, wherein said cells are prokaryotes and/or eukaryotes.

14. The preform according to claim 13, wherein the cells are fromprotists, fungi, plants and/or animals.

15. The preform according to claim 1, wherein said cell products are molecules that are bio-chemically synthesised by organisms.

16. The preform according to claim 1, wherein said cells are cells of a unicellular organism.

17. The preform according to claim 1, wherein said cells are cells of a multicellular organism.

18. A container that consists of an injection piece obtained from blowing a preform according to claim 1.

19. A method for producing a preform according to claim 1, wherein a predetermined quantity of a primary and tertiary synthetic materials are injected in a hollow mold space under a relatively high pressure p and temperature T, wherein a predetermined quantity of a secondary material is further fed in the hollow mold space under conditions of pressure and/or temperature which are substantially lower than said pressure and temperature at which said primary material and tertiary material are injected, and wherein said temperature for the feeding of secondary material is substantially room temperature,
wherein said secondary material constitutes less than 5% of the total weight of the preform and wherein said secondary material comprises a polymer bio-aggregate composed of cells and/or cell products and a polymer.

20. The method according to claim 19, wherein said secondary material is fed under normal conditions of atmospheric pressure and room temperature.

21. The method according to claim 19, wherein said secondary material is fed in a peripheral way on said primary material during the injection phase thereof and which is conveyed by the primary material to said hollow mold space over a small distance.

22. The method according to claim 19, wherein a predetermined quantity of additives is fed previously to one of said materials with a neutralizing action on undesired effects.

23. The method according to claim 19, wherein work is carried out at the working temperature range taken from the temperature interval of which the lower limit is set at substantially 100° C. under substantially one atmosphere pressure.

24. The method according to claim 19, wherein a fluid is fed cold as a secondary material under normal conditions of atmospheric pressure and room temperature.

25. The method according to claim 19, wherein the preform is replaced by a container.

26. The preform according to claim 1, wherein said secondary layer constitutes at most 1% of the total weight.

27. The preform according to claim 2, wherein said secondary layer has a thickness less than 0.01 mm.
